(19) United States
(12) Patent Application Publication
(10) Pub. No.: US 2009/0035716 A1
(43) Pub. Date: Feb. 5, 2009

(54) METHODS AND APPARATUS TO POSITION AND ALIGN TEETH USING AN EXO-SHELL

(76) Inventors: William Stuart Trimmer, Hillsborough, NJ (US); Robert Steven Sears, Round Hill, VA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/028,630

(22) Filed: Feb. 8, 2008

Related U.S. Application Data
(60) Provisional application No. 60/963,163, filed on Aug. 3, 2007.
(60) Provisional application No. 60/999,968, filed on Oct. 23, 2007.
(60) Provisional application No. 61/003,402, filed on Nov. 16, 2007.

(51) Int. Cl. A61C 7/00

(52) U.S. Cl. 433/24

(57) ABSTRACT

Methods and related apparatus for positioning and aligning any portion of the dento-facial region of a person. In one embodiment the method includes (a) providing or measuring any aspect of one or more alignment appliances to a person; (b) casting a shadow or making a mark on one or more areas of the dento-facial region of the person or the one or more alignment appliances in close proximity to one or more areas of the dento-facial region of the person with one or more light sources or marking devices; (c) measuring and analyzing data regarding one or more of the size, shape, length, and position of the one or more shadows or marks relative to other shadows or marks, one or more areas of the dento-facial region of the person or the one or more alignment appliances to obtain data; and (e) adjusting or replacing the alignment appliance or modifying the dento-facial alignment treatment plan of the person to align one or more areas of the dento-facial region of the person.

### RELATED APPLICATIONS

This application claims the benefit of and priority to U.S. Provisional Patent Application No. 60/963,163, filed on Aug. 3, 2007; U.S. Provisional Patent Application No. 60/999,968, filed on Oct. 23, 2007; and U.S. Provisional Patent Application No. 61/003,402, filed on Nov. 16, 2007.

### BACKGROUND

1. Field

The present disclosure relates generally to methods and apparatus for positioning and aligning the dento-facial region. More specifically, the present disclosure relates to methods and apparatus for using structured lighting techniques with and without an exo-shell to position and align the dento-facial region, which includes teeth, jaws and the mandibular joint.

2. General Background

A beautiful smile is a wonderful thing. It improves one's appearance and self-confidence. In addition, properly aligned teeth also improve one's dental hygiene and general health. Orthodontics is the dental specialty that involves diagnosing and converting malocclusions. By aligning the teeth, jaws and mandibular joint, which are often referred to as the dento-facial region, orthodontic clinicians can provide beautiful and healthy smiles for millions of patients. Knowledge about the forces applied to the teeth and the positions and motions of the teeth will be most helpful in enabling orthodontic treatment to become faster, more efficient, and better tolerated by the patients.

The exo-shell alignment system allows teeth to be aligned with minimal visibility of the aligning apparatus and improves the patient's appearance. The exo-shell or shell is typically a plastic structure that fits over and/or around the teeth and applies forces and/or torques on the teeth, which position and align them over time. Properly designed, the exo-shell also allows the forces to be varied as the patient inserts and removes the same or new shells at different times.

For an exo-shell to have maximum effectiveness, a number of things must be known. For example, it must be known whether the teeth are misaligned, or misregistered, relative to the shell and what is the position of the teeth in the exo-shell. Additionally, the motion of the teeth relative to the exo-shell during the course of the orthodontic treatment must also be known. It is also helpful to know the forces and torques that are or were being applied to the teeth, jaws and mandibular joint of the patient. This and other relevant information can be used to develop an exo-shell system with maximum effectiveness and speed. Ideally, the exo-shell system would also easily integrate with present orthodontic practices.

Presently, exo-shell systems do not precisely and effectively align and position teeth in the most efficient way possible. Often times, the exo-shell system does not apply the appropriate force and/or torque to the appropriate area for the correct amount of time. As a result, the patients' teeth are not properly aligned in the most efficient and effective manner possible. Accordingly, there exists a need for a better way to align and position the dento-facial region and to apply specific and appropriate forces and torques, using exo-shells and otherwise, to precisely and effectively align and position teeth in the shortest amount of time possible. The present invention provides these and other related advantages.

### SUMMARY

The present disclosure is directed to methods and related apparatus for positioning and aligning any portion of the dento-facial region of a person. In one embodiment, a method for aligning the dento-facial region of a person is provided. The method includes, but is not limited to: (a) providing or measuring any aspect of one or more alignment appliances to a person to align the dento-facial region of the person; (b) casting of a shadow or making of a mark on one or more areas of the dento-facial region of the person or the one or more alignment appliances in close proximity to one or more areas of the dento-facial region of the person with one or more light sources or marking devices; (c) measuring one or more of the size, shape, length, and position of the one or more shadows or marks relative to other one or more shadows or marks, one or more areas of the dento-facial region of the person or the one or more alignment appliances to obtain data; (d) analyzing the data regarding the one or more of the size, shape, length, and position of the one or more shadows relative to other shadows or marks, one or more areas of the dento-facial region of the person or the one or more alignment appliances to determine one or more of the position, the morphology, the applied force, and the applied torque related to a portion of the dento-facial region; and (e) adjusting or replacing the alignment appliance or modifying the dento-facial alignment treatment plan of the person based on the results of analyzing the data regarding the one or more of the size, shape, length, and position of the one or more shadows relative to other shadows or marks, one or more areas of the dento-facial region of the person or the one or more alignment appliances to determine one or more of the position, the morphology, the applied force, and the applied torque related to a portion of the dento-facial region to align one or more areas of the dento-facial region of the person.

In an aspect of at least one embodiment of the present invention, an imaging system is used to measure one or more of the size, shape, length, and position of the one or more shadows relative to other shadows or marks, the one or more areas of the dento-facial region of the person or the one or more alignment appliances. The imaging system may be any device use to take an image of any area of the dento-facial region.

In another aspect of at least one embodiment of the present invention, a camera is used to measure one or more of the size, shape, length, and position of the one or more shadows relative to other the one or more shadows or marks, the one or more areas of the dento-facial region of the person or the one or more alignment appliances.

In another aspect of at least one embodiment of the present invention, one or more optical elements provide one or more light sources or marking devices for casting a shadow or making a mark on the one or more areas of the dento-facial region of the person or the appliance in close proximity to one or more areas of the dento-facial region of the person.

In another aspect of at least one embodiment of the present invention, one or more optical elements are located on one or more aligner shells.

In another aspect of at least one embodiment of the present invention, the one or more alignment appliances is an exo-shell or mold.

In another aspect of at least one embodiment of the present invention, the one or more optical elements are one or more fiducials.

In another aspect of at least one embodiment of the present invention, the one or more fiducials are opaque or allow a specialized color or polarization of light to pass through the one or more fiducials.

In another aspect of at least one embodiment of the present invention, the one or more optical elements are one or more polarizers, quarter wave plates, wave plates, lens, retro reflectors, diffraction gradings or Moire patterns.

In another aspect of at least one embodiment of the present invention, adjusting the alignment appliance produces an alignment device with at least one undulating surface.

In another aspect of at least one embodiment of the present invention, the undulating surface on the alignment appliance casts shadows or makes markings on the dento-facial region of the person or on a dental appliance and the shadows or markings are used to measure one or more of the size, shape, length, and position of the one or more shadows or marks relative to other one or more shadows or marks to obtain data.

In another aspect of at least one embodiment of the present invention, the undulating surface produces one or more of a lens, a retro reflector, a diffraction grading, a prism, or other optical element.

In another aspect of at least one embodiment of the present invention, the undulating surface is designed to receive an elastic member captured between the one or more alignment appliances and the dento-facial region of the person.

In another aspect of at least one embodiment of the present invention, the undulating surface is designed to capture and hold the elastic member.

In another aspect of at least one embodiment of the present invention, the undulating surface makes the one or more alignment apparatus more or less rigid in desired regions.

In another embodiment of the present invention, a method of determining the force, displacement or torque of an alignment appliance is provided. The method includes but is not limited to: (a) positioning an elastic member interposed between two or more teeth or an alignment appliance and the one or more teeth thereby distorting the elastic member; (b) measuring the distortion of the elastic member; and (c) using the distortion of the elastic member to calculate one or more of the displacement, force and torque on the two or more teeth or the alignment appliance and the one or more teeth.

In another aspect of at least one embodiment of the present invention, measuring the distortion of the elastic member is measured optically.

In another embodiment of the present invention, a method is provided for positioning or aligning teeth. The method includes but is not limited to: (a) measuring the separation between one or more teeth of a person and one or more alignment appliances worn by the person at a first point in time; (b) measuring the separation between the one or more teeth of the person and the one or more alignment appliances worn by the person at a second later point in time; (c) analyzing or determining the separation between the one or more teeth of the person and one or more alignment appliances worn by the person at the second later point in time to determine the movement of the one or more teeth of the person relative to the one or more alignment appliances worn by the person from the first point in time to the second later point in time; and (d) adjusting or replacing the one or more alignment appliances worn by the person or altering the treatment plan of the person based on the movement of the one or more teeth of the person as compared to the one or more alignment appliances worn by the person to align one or more teeth.

In another aspect of at least one embodiment of the present invention, the methods additionally comprise adjusting the one or more alignment appliances, causing at least a portion of an alignment appliance to apply one or more force pyramids to the one or more teeth.

In another aspect of at least one embodiment of the present invention, adjusting the one or more alignment appliances includes causing at least a portion of the alignment appliance to take a serpentine shape, contain a serpentine pattern and/or contain ridges.

In another aspect of at least one embodiment of the present invention, the data from measuring the separation between one or more teeth and one or more alignment appliances is stored in fixed medium.

In another aspect of at least one embodiment of the present invention, the methods additionally comprise analyzing the stored data in the fixed medium to determine what forces should be applied to the one or more teeth to cause them to align relative to each other.

### DRAWINGS

The above-mentioned features and objects of the present disclosure will become more apparent with reference to the following description taken in conjunction with the accompanying drawings wherein like reference numerals denote like elements and in which:

FIG. 1 shows a method of using a light or marking source to create shadows or markings on an alignment appliance and one or more teeth of a person in close proximity to the alignment appliance.

FIG. 2 shows a method of using multiple light or marking sources and a camera to create shadows or markings on an alignment appliance and one or more teeth in close proximity to the alignment appliance.

FIG. 3 shows a method of using multiple light or marking sources and a camera to create shadows or markings on an alignment appliance and one or more teeth in close proximity to the alignment appliance where the shadows or markings on the one or more teeth move after the one or more teeth have moved.

FIG. 4 shows a method of using multiple light or marking sources and a camera to create shadows or markings on an alignment appliance and one or more teeth in close proximity to the alignment appliance and the movement of the marking and shadows with corresponding movement of the one or more teeth.

FIG. 5 shows a method of using a camera and multiple light or marking sources that pass through an alignment appliance with an undulation such that shadows are cast upon a tooth in such a manner that measurements of the shadows provide information about one or more parameters of interest.

FIG. 6 shows a method of using multiple light or marking sources and a camera to create shadows or markings on an alignment appliance having another type of one or more undulations and one or more teeth in close proximity to the alignment appliance.

FIG. 7 shows a method of using multiple light or marking sources and a camera to create shadows or markings on an alignment appliance having an alternative configuration (e.g., serpentine pattern or shape) and one or more teeth in close proximity to the alignment appliance.

FIG. 8 shows a method of using multiple light or marking sources and a camera to create shadows or markings on an alignment appliance having one or more force pyramids (where the force pyramid applies a force and/or torque to an indicated portion of one or more teeth as shown) and one or more teeth in close proximity to the alignment appliance.

### DETAILED DESCRIPTION

The present disclosure is directed to methods and related apparatus for positioning and aligning any portions of the dento-facial region relative to each other. The dento-facial region generally includes one or more teeth, the jaw or jaws and the mandibular joint.

In one embodiment, a method for aligning the dento-facial region of a person is provided. The method includes, but is not limited to: (a) providing or measuring any aspect of one or more alignment appliances to a person to align the dento-facial region of the person; (b) casting a shadow or making a mark on one or more areas of the dento-facial region of the person or the one or more alignment appliances in close proximity to one or more areas of the dento-facial region of the person with one or more light sources or marking devices; (c) measuring one or more of the size, shape, length, and position of the one or more shadows or marks (or their angles and angles of the dento-facial region or one or more appliances) relative to other one or more shadows or marks, one or more areas of the dento-facial region of the person or the one or more alignment appliances to obtain data; (d) analyzing the data regarding the one or more of the size, shape, length, and position of the one or more shadows relative to other shadows or marks, one or more areas of the dento-facial region of the person or the one or more alignment appliances to determine one or more of the position, the morphology, the applied force, and the applied torque related to a portion of the dento-facial region; and (e) adjusting or replacing the alignment appliance or modifying the dento-facial alignment treatment plan of the person based on the results of analyzing the data regarding the one or more of the size, shape, length, and position of the one or more shadows relative to other shadows or marks, one or more areas of the dento-facial region of the person or the one or more alignment appliances to determine one or more of the position, the morphology, the applied force, and the applied torque related to a portion of the dento-facial region to align one or more areas of the dento-facial region of the person.

For example and not by way of limitation, in one aspect of the at least one embodiment of the present invention, an alignment appliance, which is any device used to position or align any portion of the dento-facial region, is provided to the patient desiring alignment or positioning of the dento-facial region. In another aspect of at least one embodiment, some aspect (e.g., the size, shape rigidity, proximity to the dento-facial region) of the alignment appliance of the patient desiring alignment or position of the dento-facial region is measured.

For example and not by way of limitation, in one aspect of at least one embodiment of the present invention, a light source is cast on one or more areas of the dento-facial region (e.g., teeth) of the person and an alignment appliance (e.g., exo-shell). The distance between the areas of the dento-facial region and the alignment appliance is measured and analyzed to determine the position and forces and torques placed on the dento-facial region and to determine if any movement has been made and the alignment appliance should be adjusted or replaced with another alignment appliance that places the proper forces and torques on the one or more areas of the dento-facial region of the person to align or position the one or more areas of the dento-facial region of the person.

In yet another aspect of at least one embodiment of the present invention, casting a shadow or making a mark on one or more areas of the dento-facial region of the person or the one or more alignment appliances in close proximity to one or more areas of the dento-facial region of the person is performed using any light source (e.g., fluorescent, incandescent light, light-emitting diode or laser) or any marking device (e.g., wax pen or other marking device).

In another aspect of at least one embodiment of the present invention, an imaging system is used to measure one or more of the size, shape, length, and position of the one or more shadows relative to other shadows or marks, the one or more areas of the dento-facial region of the person or the one or more alignment appliances.

In another aspect of at least one embodiment of the present invention, a camera is used to measure one or more of the size, shape, length, and position of the one or more shadows relative to other shadows or marks, the one or more areas of the dento-facial region of the person or the one or more alignment appliances.

In another aspect of at least one embodiment of the present invention, one or more optical elements provide one or more light sources or marking devices for casting a shadow or making a mark on the one or more areas of the dento-facial region of the person or the appliance in close proximity to one or more areas of the dento-facial region of the person.

In another aspect of at least one embodiment of the present invention, the one or more alignment appliances is one or more aligner shells, exo-shells or molds.

In another aspect of at least one embodiment of the present invention, one or more optical elements are located on one or more aligner shells.

In another aspect of at least one embodiment of the present invention, the one or more alignment appliances is an exo-shell or mold.

In another aspect of at least one embodiment of the present invention, the one or more optical elements are one or more fiducials that are opaque or allow a specialized color or polarization of light to pass through the fiducial.

In another aspect of at least one embodiment of the present invention, the one or more optical elements are one or more polarizers, quarter wave plates, wave plates, lens, retro reflectors, diffraction gradings or Moiré patterns.

In another aspect of at least one embodiment of the present invention, adjusting the alignment appliance or the specifications for manufacturing the alignment appliance with at least one undulating surface.

In another aspect of at least one embodiment of the present invention, the undulating surface on the alignment appliance casts shadows or makes markings on the dento-facial region of the person and the shadows or markings are used to measure one or more of the size, shape, length, and position of the one or more shadows or marks relative to other shadows or marks to obtain data.

In another aspect of at least one embodiment of the present invention, the undulating surface produces one or more of a lens, a retro reflector, a diffraction grading, a prism, or other optical element.

In another aspect of at least one embodiment of the present invention, the undulating surface is designed to receive an elastic member captured between the one or more alignment appliances and the dento-facial region of the person.

In another aspect of at least one embodiment of the present invention, the undulating surface is designed to capture and hold the elastic member.

In another aspect of at least one embodiment of the present invention, the undulating surface makes the one or more alignment apparatuses more or less rigid in desired regions.

In another embodiment of the present invention, a method of determining the force, displacement or torque of an alignment appliance is provided. The method comprises: (a) positioning an elastic member interposed between two or more teeth or an alignment appliance and the one or more teeth thereby distorting the elastic member; (b) measuring the distortion of the elastic member; and (c) using the distortion of the elastic member to calculate one or more of the displacement, force and torque on the two or more teeth or the alignment appliance and the one or more teeth.

In another aspect of at least one embodiment of the present invention, the elastic member is a device that measures forces or torques applied to it.

In another aspect of at least one embodiment of the present invention, the distortion of the elastic member is measured optically.

In another embodiment of the present invention, a method is provided for positioning or aligning teeth. The method comprises: (a) measuring the separation between one or more teeth of a person and one or more alignment appliances worn by the person at a first point in time; (b) measuring the separation between the one or more teeth of the person and the one or more alignment appliances worn by the person at a second later point in time; (c) analyzing the separation between the one or more teeth of the person and one or more alignment appliances worn by the person at the second later point in time to determine the movement of the one or more teeth of the person relative to the one or more alignment appliances worn by the person from the first point in time to the second later point in time; and (d) adjusting or replacing the one or more alignment appliances worn by the person or altering the treatment plan of the person based on the movement of the one or more teeth of the person as compared to the one or more alignment appliances worn by the person to align one or more teeth.

In another aspect of at least one embodiment of the present invention, the methods additionally comprise adjusting the one or more alignment appliances, causing at least a portion of an alignment appliance to apply one or more force pyramids to the one or more teeth.

In another aspect of at least one embodiment of the present invention, adjusting the one or more alignment appliances, causing at least a portion of the alignment appliance to take a serpentine shape, contain a serpentine pattern and/or contain ridges.

In another aspect of at least one embodiment of the present invention, the data from measuring the separation between one or more teeth and one or more alignment appliances is stored in a fixed medium.

In another aspect of at least one embodiment of the present invention, the methods additionally comprise analyzing the stored data in the fixed medium to determine what forces should be applied to the one or more teeth to cause them to align relative to each other.

As described in detail herein, various embodiments of the present invention include measuring the use of shadows or markings. Shadows and similar markings can conveniently be used to measure the height of objects. For example, by knowing the angle of the sun and the length of the obelisk shadow or marking, the height of the obelisk can be calculated. In at least one embodiment, a camera observation point, an exo-shell, and several teeth are provided. The method allows the teeth to be aligned and positioned relative to one another. For example and not by way of limitation, a light source outward of the camera (or other device that provides a similar marking) is provided. The light source creates a shadow typically on the tooth due to an opaque fiducial on the shell. Knowing the distance between the camera and light source and the focal length of the camera, one can calculate the angle Theta in which the optical axis of the camera and the direction of the light source meet in the region of the fiducial. This angle is the same as the angle of projection of the shadow and is again Theta. The angle Theta can be calculated as the inverse tangent of the distance between the camera and light source divided by the focal length of the camera.

Since distance s is measured by analyzing the camera's image and knowing the scale, which is the relationship between pixels measured in the camera and physical dimensions of objects imaged by the camera, one can now solve the equation to determine Theta.

If the region of the tooth under the fiducial has a curvature, then one needs to solve an image relating to the intersection of the line defined by the shadow's edge and the curve generated by the curvature. There are well-known mathematical techniques for finding this intersection and calculating the separation or distance between the fiducial on the shell and the tooth. In at least one embodiment, the curvature of the one or more teeth is known because it is measured first, possibly during the initial work up on the person desiring alignments of the teeth using an alignment appliance like exo-shells or aligner shells.

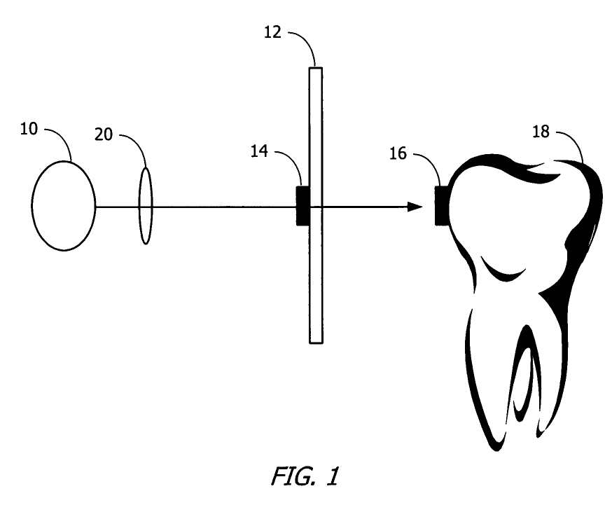

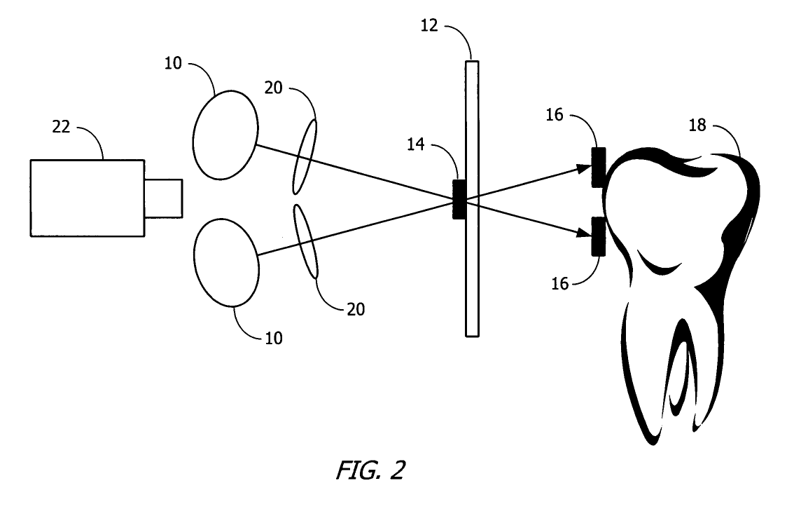

In another embodiment of the present invention, an implementation of which is shown in FIG. 1, the large tooth represents the one or more teeth that the person would like aligned or positioned. Near, but not touching the one or more teeth, is the shell with a single simple fiducial. In at least one embodiment, the fiducial is a dot, sometimes colored, that appears (e.g., by being painted) on the alignment apparatus (e.g., exo or aligner shell). Structured or other light is used in conjunction with the fiducial to measure the physical separation between the alignment appliance and the one or more teeth at the point of the fiducial. As shown in FIG. 2, two light sources, preferably collimated, illuminate the tooth and fiducial from different angles. Each one of these light sources produces a shadow behind fiducials on the tooth.

In at least one embodiment, the two light sources are of different colors (e.g., red and green). For example, the red light source produces a shadow on the tooth when viewed in red light and the green light source produces a shadow of the fiducial on the tooth from a second angle. As shown in FIG. 2, an imaging device (e.g., video camera) views the fiducial and one or more teeth between the two light sources. Accordingly, the camera sees a shadow in red light to one side and a shadow in green light to the other side. As the shell moves farther from the tooth, the separation between these two shadows increases. Indeed, the physical distance between the shell and the tooth can be calculated by viewing the separation between the red shadow and the green shadow. This separation can be used to determine and analyze progress in the movement of the dento-facial region and used as data to determine the any appropriate changes to the alignment device or subsequent alignment appliance.

It should be appreciated that the alignment appliance can contain one or more fiducial marks and, at the point of each fiducial, the separation between the shell and one or more teeth can be measured to provide the contour of the tooth relative to the shell. Other known methods of determining the contour of the one or more teeth can also be used.

By determining the contour of the tooth, the position of the tooth relative to the shell can be determined. In this manner, movements of the one or more teeth during the course of an orthodontic treatment can be measured as a function of time. For example, the position of the one or more teeth relative to the position of the shell that contains the one or more teeth can be measured at the beginning of the treatment with that particular alignment appliance, like an exo-shell, and the position of the one or more teeth as they move under the influence of the alignment appliance can be measured periodically as needed (e.g., at each orthodontic office visit). If the one or more teeth are not moving or aligning in the prescribed manner, immediate corrective action can be taken at the time of first deviance before substantial complications develop or additional time is wasted. Also, this and other methods disclosed herein provide an indication of the forces and torques being applied to the one or more teeth. This is because the forces or torques from the alignment appliance are applied to the one or more teeth at points of contact between the teeth and alignment appliance.

It should be appreciated that several different kinds of light, including but not limited to structured light, or other marking methods can be used as part of the present invention.

In at least one other embodiment, a light emitting diode, (e.g., LED) is placed at the focal point of a lens. The lens collimates the light to produce a clear shadow on the tooth. A low-wattage laser can also be used as a collimated source of light. A small incandescent lamp, such as a grain of wheat, or an incandescent light with a pinhole, could also be used as the source of light.

In at least one other embodiment, two light sources are strobed (with or without being in synch with the camera) such that only one of the light sources is illuminating the fiducial and one or more teeth in different camera frames.

In at least one embodiment, the camera used to acquire the images is a modified intra-oral camera or a specially designed microscope and video camera (e.g., microscope developed by Right Force Orthodontics, Hillsborough, N.J.).

In another aspect of at least one embodiment, the light sources are arranged such that they illuminate only part of the camera's field of view. In certain circumstances, doing so simplifies the vision algorithms that analyze the image.

Structured light is a convenient way to measure physical dimensions. In a typical example, a beam of light is directed towards a region that is being imaged. This beam of light can be a sheet of light, a thin pencil of light, a cylinder of light, or an array of different light beams. Typically in structured light one has already measured and knows the path of the light beam in the region of interest. By knowing the path of the light beam and where one or several beams strike an object being imaged, one can calculate information about the physical dimensions of the object.

If a camera is between two sheets of light that are converging on a point, the two sheets of light are analogous to two pieces of paper, or planes, being held such that they converge to a common line. If an object lies at the common line of these two sheets of light, a single bright line will be seen when imaged by the camera. As the object moves closer to the camera or farther from the camera, this line will break into two lines as seen on the object. The further the object from the common convergent line, the wider the separation between lines and the object.

By recording the separation between the two lines in the image of the camera, one knows how far that object is from the camera. The ambiguity of not knowing whether the object lies closer to or further from the camera than the convergent line can be removed by having these two sheets of light, different colors or displaying other characteristic optical properties such as polarization or width. For example, if the sheet of light coming in from the right is red and the sheet of light coming in from the left is blue, if the object is closer than the common convergent line, the red spot will lie to the right and the blue spot will lie to the left, and, when the object is on the other side of the convergent line, the colors will interchange.

In yet another embodiment, one or more beams of light are arranged to meet at common points or to remain distinct and the different beams can have different optical properties, such as color or polarization, or can be strobed on and off in a sequentially convenient manner.

In yet another embodiment, two converging sheets of light strike an object that, for example, may be shaped roughly like a piece of pie that is lying on a flat surface. If these two sheets of light converge at a common line on the flat surface, then as long as the sheets of light do not impinge on the pie, the sheets of light will appear as a single line. If the point of the piece of pie crosses onto these two sets of light, there will now be two distinct lines of light on the upper surface of the pie and the separation between these lines of light indicates the height of the pie. As the sheets of light transverse a broader and broader region of the piece of pie, the length of the two distinct lines will increase.

Alignment appliances come in many forms and varieties. For example and not by way of limitation, exo-shell or aligner shells are two types of alignment appliances used to straighten or position teeth. Typically, these devices are thin plastic or plastic like inserts that fit over the teeth, take the general shape of the teeth, and grossly apply forces to the teeth to move the teeth into their correct position. During the course of treating a patient, a number of different alignment appliances can be used to successfully and incrementally move the teeth into their proper positions.

Often times, the alignment appliances are made using a two-step process where a mold is made with stereo lithography and the alignment appliances are formed over the top of these molds. Generally, one mold is required for each appliance used by the patient.

One way of manufacturing an alignment appliance starts with a vat of UV curable epoxy. A laser beam strikes and writes the bottom layer of the mold structure onto this platform slightly submerged in the UV curable epoxy. Then the platform is lowered slightly and the next layer of the mold is cured with the UV laser. This is done sequentially until all the layers making up the mold have been fabricated. This mold is then removed from the epoxy, cleaned, and prepared. A thin sheet of plastic is then formed over the top of the mold, and this formed thin sheet becomes the alignment appliance. The appropriate series of these appliances are then sent to the orthodontist where he or she successively uses the different appliances with the patient to gradually align teeth.

Because the process to manufacture the mold is often digitally controlled by a computer that gives instructions to scan the UV laser, it is easy to modify the mold using computer programs. For example, one can make the surface of the mold undulate with appropriate modifications to the computer program. These undulations can then be used for a number of different purposes as described below.

In one embodiment, undulations in the mold, which are propagated to undulations in the alignment appliance, can be used as fiducials to measure the spacing and interactions of the appliance and one or more teeth. For example, if the surface of the alignment appliance has a short-shaped v-groove undulation and one of the light sources is traveling in the general direction of one side of the v-groove of the undulation, this will cast a shadow upon the tooth in a manner similar to a fiducial. Alternatively, if the light source is traveling at a slightly different angle than one surface of the v-groove, then the grazing incidence will reflect a bright region upon the tooth that can also be used as a fiducial indicator. In another embodiment, the ridges left by the process of using molded layers can be used as the appropriate undulations.

In yet another embodiment, the undulations in the alignment appliance can also be used to make other optical elements such as lenses, a retro reflector, a diffraction grading, a prism, or other optical elements.

In yet another embodiment, the undulations can also be used to make a connection between the alignment appliance and an elastic member. This connection is similar to a snap used on clothing to close a pocket. Here, the alignment appliance may have a receptacle cavity into which the elastic member can be snapped with the application of the correct amount of force.

It should be appreciated that the undulations of the alignment appliance can also be used to change the compliance of the alignment appliance. The appliance can be made more rigid by forming undulations that take the shape of a herringbone, honeycomb, or egg crate. Certain patterns and shapes have certain strengths and weaknesses. For example, an egg crate pattern is strong along the diagonal direction and weak along the rows or columns between the egg cradles.

Additionally, the alignment appliance can be modified to make it strong in one direction and weak in an orthogonal direction. For example, a series of v-grooves are strong along the direction of the v-groove and weak at right angles. The ability to tailor the strength and compliance of the alignment appliance has several advantages. For example, the alignment appliance can be made stronger, and this strength can be used to couple forces from one region of the dental arch to another. With prior art alignment devices, when a force is applied to a tooth, the two adjacent teeth commonly receive the opposite force, which may not be desirable. Using the strength of the alignment appliance, however, this force can be transmitted away from the adjacent teeth to distinct teeth or to some other orthodontic appliance. This variable compliance is useful when one wants to apply force in a specific direction. By making the alignment appliance strong in certain directions and weak in other directions, the appliance applies forces only in the desired direction.

In another embodiment, the morphology of the alignment appliance is used to make fiducials. Consider the simple example of an alignment appliance having a region with a serpentine pattern. Light from the first collimated source striking the alignment appliance passes unhindered through most of the alignment appliance. However, if a light is passing through the alignment apparatus along the direction of one of the sides of the v-grove, this light will be scattered or absorbed, and this region will act similar to a fiducial producing a dark shadow on the dento-facial region of interest.

In yet another embodiment, as shown in FIG. 1, a method is provided for using a light or marking source to create shadows or markings on an alignment appliance and one or more teeth of a person in close proximity to the alignment appliance. As part of the method, a light or other marking source 10, which may or may not be adjusted or modified (e.g., collimated) using a device 20 is shown or placed on an alignment appliance 12, which in at least one embodiment is opaque, creating a marking or shadow 14 and a dot or shadow on one or more teeth 18 (or other area of the dento-facial region needing alignment). The positions of the markings and shadows relative to each other and alignment appliances and one or more teeth (or other area of the dento-facial region) provide information regarding the movement of the one or more teeth (or other area of the dento-facial region), which can be used to modify the alignment apparatus to apply appropriate forces to the desired areas of the dento-facial region and to understand which forces and torques result in the desired alignment and positioning of the dento-facial region.

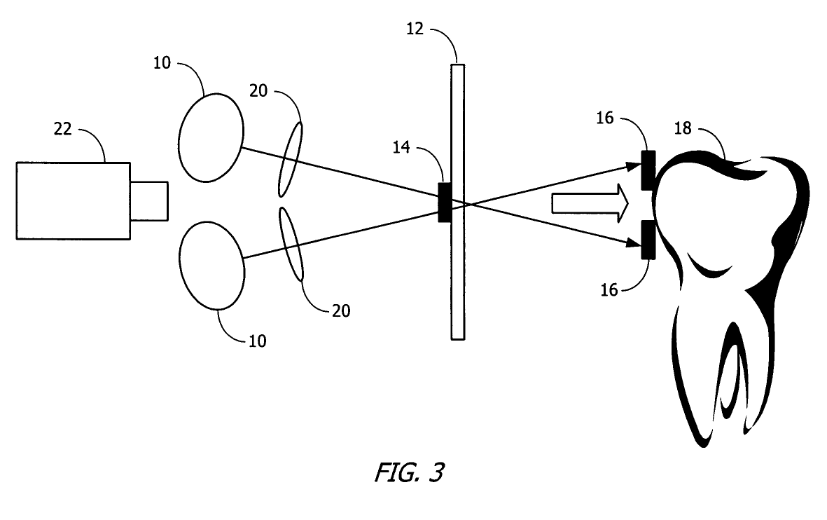

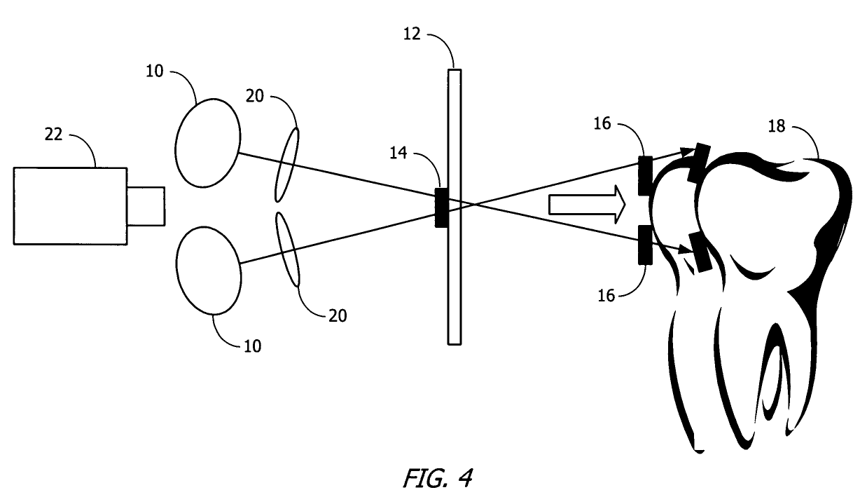

In yet another embodiment, as shown in FIG. 2, a method is provided for using one or more cameras 22 and multiple light or marking sources 10, which can be modified using any known light, of marking modifying device 20 (e.g., collimator) and to create shadows or markings 14 and 16 on an alignment appliance 12 and one or more teeth 18, respectively, in close proximity to the alignment appliance 12. The positions of the markings and shadows relative to each other and alignment appliances and one or more teeth (or other area of the dento-facial region) provides information regarding the movement of the one or more teeth (or other area of the dento-facial region), which can be used to modify the alignment apparatus to apply appropriate forces to the desired areas of the dento-facial region and to understand which forces and torques result in the desired alignment and positioning of the dento-facial region. FIGS. 3 and 4 show the effect of the movement of the teeth on the position of the marking or shadows.

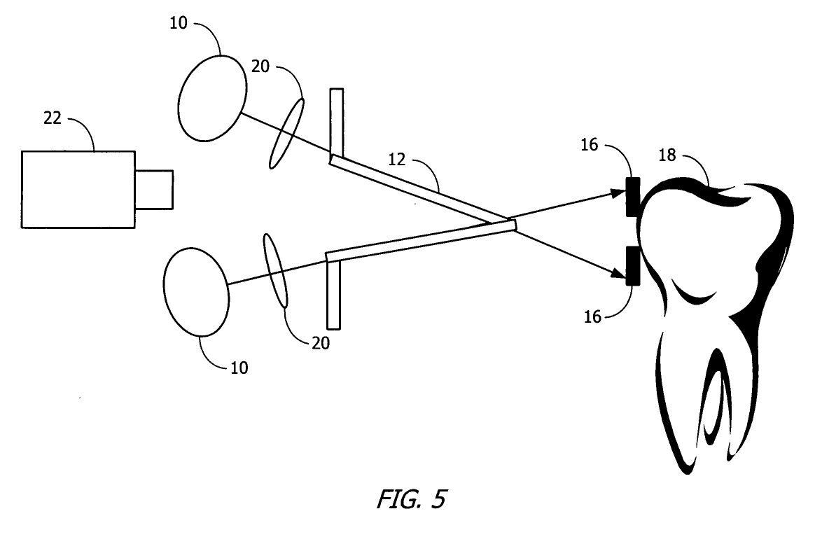

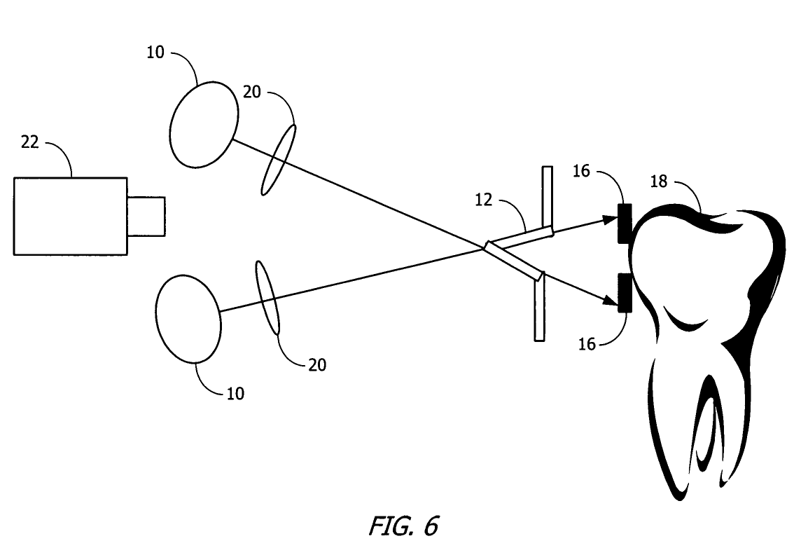

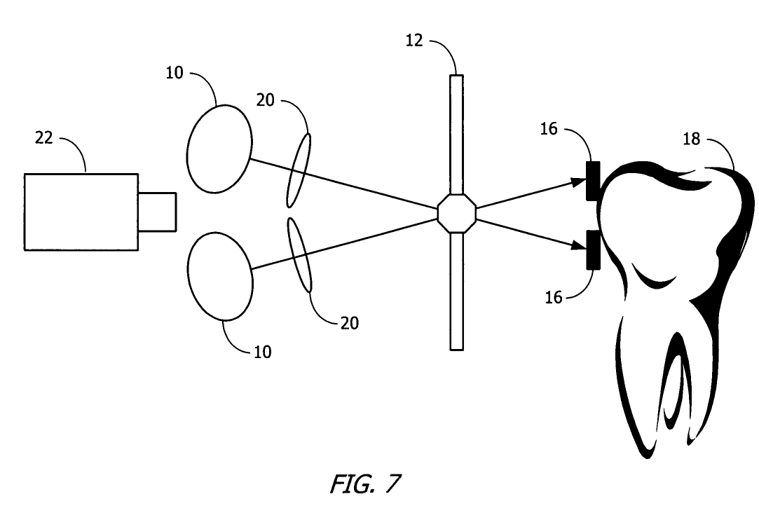

In yet another embodiment, as shown in FIG. 5, a method is provided for using a camera 22 and multiple light or marking sources 10 that can pass through a known device that modifies or adjusts the light 20 and passes though an alignment appliance 22, having one or more undulations such that shadows or marking 16 are cast upon one or more teeth in such a manner that measurements of the shadows provide information about one or more parameters of interest. FIGS. 6 and 7 show a similar embodiment except that the alignment appliance has different undulations and configurations.

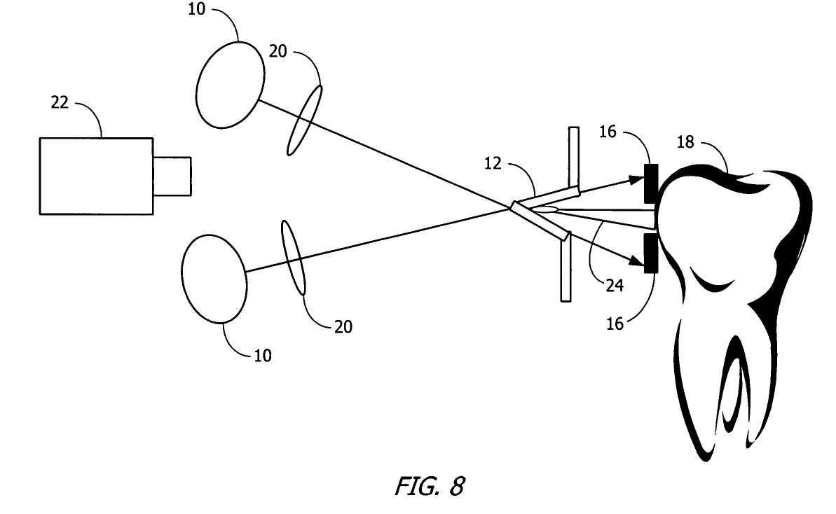

In yet another embodiment, as shown in FIG. 8, a method is provided for using multiple light or marking sources 10 and a camera 22 to create shadows or markings 16 on an alignment appliance 12 having one or more force pyramids 24 (where the force pyramid applies a force and/or torque on an indicated portion of one or more teeth as shown) and one or more teeth in close proximity to the alignment appliance. The positions of the markings and shadows relative to each other and the alignment appliance and one or more teeth (or other area of the dento-facial region) provide information regarding the movement of the one or more teeth (or other area of the dento-facial region), which can be used to modify the alignment apparatus to apply appropriate forces to the desired areas of the dento-facial region and to understand which forces and torques result in the desired alignment and positioning of the dento-facial region.

The shells used in orthodontics to align teeth are typically made by making a form using stereolithography and then over-molding the plastic alignment appliance on this form. Stereolithography works by raster or vector scanning a laser over the surface of an epoxy bath. The raster or vector scan is typically controlled by a computer working from a digital solid model. To form the serpentine shape one has only to modify the software to produce an extra concave or convex surface on the form. When the alignment appliance is over-molded, the concavity of the form is replicated onto an alignment appliance producing the desired serpentine morphology on the alignment appliance.

The serpentine morphology on the alignment appliance (or the painted or opaque fiducial dots described above) in collaboration with a force pyramid or a force cone can be used to measure the forces and torque applied by the shell onto the tooth. Consider the tooth force pyramid 24 shown in FIG. 8. The force pyramid can be attached to the tooth using techniques that are common in dentistry and orthodontics. The force pyramid is topped with some structure, such as a bulbous protrusion shown on top of the force pyramid 24. The alignment appliance has a matching bulbous region. When these two are brought together and a force applied, the bulbous region on the shell seats into the shell or snaps onto the bulbous region of the force pyramid 24 in a manner similar to snaps used on clothing. Hence, the alignment appliance is now rigidly attached to the top of the force pyramid. The appliance and force pyramid can also be held together only by the forces applied by the appliance to the pyramid. When the appliance applies forces onto the force pyramid through the bulbous region, the regions of the appliance around the bulbous region and/or the force pyramid distort and the pyramid itself may also distort. For example, as the alignment appliance applies forces on the force pyramid 24, the fiducials move and their shadows move on the force pyramid or the tooth. The motions of the fiducial shadows can be correlated with the forces that the shell is applying on the force pyramid and hence on the tooth. Using a single force pyramid attached to the shell, forces in three different directions (Fx, Fy and Fz) can be measured. In some cases some torques can also be measured with a single force pyramid.

The use of two or three force pyramids or force cones attached to a tooth allow torques and forces to be measured. In accordance with the present invention, force pyramids or cones can be attached to the teeth using techniques commonly used in dentistry and orthodontics. For example, a special alignment appliance can be designed which holds the force cones or force pyramids prior to attachment. This special alignment appliance is placed over the teeth aligning the force pyramids to the correct position on the teeth. Ultraviolet light or similar techniques can then be used to attach the correctly positioned force cones or pyramids to the teeth.

It should be apparent that various morphologies for the shell can be used to cover extended regions of the alignment appliance. For example, the serpentine morphology can also cover extended regions of the appliance. In doing so, the serpentine structures change the strength and rigidity of the shell anisotropically.

For example, if the serpentine ridges all lie parallel, as in a potato chip with ridges, then the serpentine appliance will be strong in one direction and flexible in the other direction. This ability to make the appliance an isotropic appliance can be useful to exert the desired forces in only one direction. For example, if one wishes to apply strong forces in one direction but not another, the serpentine morphology on the appliance can be designed so the appliance can only produce strong forces in one direction. In doing so, the forces will only be applied in the correct direction to provide the most efficient and maximal results.

The serpentine morphology can also be used to increase the rigidity of the alignment appliance. For example, a herringbone structure can be used. In at least one embodiment, a strengthened alignment appliance is used in conjunction with headgear to apply forces to a desired region of one or more teeth needing positioning or alignment. This also has the added advantage of allowing forces to be applied to one tooth without a cross-coupling to the neighboring teeth. The traditional orthodontic bracket and wire system does not have this advantage. As a result, the dento-facial region can be aligned and positioned in much faster and more effective manner. Using a serpentine structure on the alignment appliance allows one to build a system that decouples the interactions between teeth and is clinically much easier to use and more deterministic and precise in the forces being applied.

Using the new systems and methods described herein, one can apply more precise forces and torques to the teeth and observe the motion of the teeth during treatment. Aberrations from the treatment plan are easily detected early, before mismovements of the teeth are made. Additionally, the scientific data that can be obtained from the measurements and movements will be invaluable to improving the patient's treatment and developing improved treatments for future patients. This valuable database can be used to design improved orthodontic systems, provide the orthodontist with improved treatment plans, and evolve orthodontics from an art to a science.

While the systems, apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method for aligning the dento-facial region of a person, the method comprising:
a. providing or measuring any aspect of one or more alignment appliances to a person to align the dento-facial region of the person;
b. casting a shadow or making a mark on one or more areas of the dento-facial region of the person or the one or more alignment appliances in close proximity to one or more areas of the dento-facial region of the person with one or more light sources or marking devices;
c. measuring one or more of the size, shape, length, and position of the one or more shadows or marks relative to other shadows or marks, one or more areas of the dento-facial region of the person or the one or more alignment appliances to obtain data;
d. analyzing the data regarding the one or more of the size, shape, length, and position of the one or more shadows relative to other shadows or marks, one or more areas of the dento-facial region of the person or the one or more alignment appliances to determine one or more of the position, the morphology, the applied force, and the applied torque related to a portion of the dento-facial region; and
e. adjusting or replacing the alignment appliance or modifying the dento-facial alignment treatment plan of the person based on the results of analyzing the data regarding the one or more of the size, shape, length, and position of the one or more shadows relative to other shadows or marks, one or more areas of the dento-facial region of the person or the one or more alignment appliances to determine one or more of the position, the morphology, the applied force, and the applied torque related to a portion of the dento-facial region to align one or more areas of the dento-facial region of the person.

2. The method of claim 1, wherein measuring one or more of the size, shape, length, and position of the one or more shadows relative to other shadows or marks, the one or more areas of the dento-facial region of the person or the one or more alignment appliances is performed by an imaging system.

3. The method of claim 1, wherein measuring one or more of the size, shape, length, and position of the one or more shadows relative to other the one or more shadows or marks, the one or more areas of the dento-facial region of the person or the one or more alignment appliances is measured by a camera.

4. The method of claim 1, wherein providing one or more light sources or marking devices for casting a shadow or making a mark on the one or more areas of the dento-facial region of the person or the appliance in close proximity to one or more areas of the dento-facial region of the person is provided by one or more optical elements.

5. The method of claim 4, wherein the one or more optical elements are located on one or more aligner shells.

6. The method of claim 1, wherein the alignment appliance is an exo-shell or mold.

7. The method of claim 4, wherein the one or more optical elements are one or more fiducials that are opaque or allow a specialized color or polarization of light to pass through the fiducial.

8. The method of claim 4 wherein the one or more optical elements are one or more polarizers, quarter wave plates, wave plates, lens, retro reflectors, diffraction gradings or Moire patterns.

9. The method of claim 1, wherein, adjusting the alignment appliance produces an alignment device with at least one undulating surface.

10. The method of claim 9, wherein the undulating surface on the alignment appliance casts shadows or makes markings on an the dento-facial region of the person and the shadows or markings are used to measure one or more of the size, shape, length, and position of the one or more shadows or marks relative to other shadows or marks to obtain data.

11. The method of claim 9, wherein the undulating surface produces one or more of a lens, a retro reflector, a diffraction grading, a prism, or other optical element.

12. The method of claim 9, wherein the undulating surface is designed to receive an elastic member captured between the one or more alignment appliances and the dento-facial region of the person.

13. The method of claim 9, wherein the undulating surface is designed to capture and hold the elastic member.

14. The method of claim 9, wherein the undulating surface makes the one or more alignment apparatuses more or less rigid in desired regions.

15. A method of determining the force, displacement or torque of an alignment appliance, the method comprising:
a. positioning an elastic member interposed between two or more teeth or an alignment appliance and the one or more teeth thereby distorting the elastic member;
b. measuring the distortion of the elastic member; and
c. using the distortion of the elastic member to calculate one or more of the displacement, force, and torque on the two or more teeth or the alignment appliance and the one or more teeth.

16. The method of claim 15, wherein measuring the distortion of the elastic member is measured optically.

17. A method for aligning one or more teeth of a person, the method comprising:
a. measuring the separation between one or more teeth of a person and one or more alignment appliances worn by the person at a first point in time;
b. measuring the separation between the one or more teeth of the person and the one or more alignment appliances worn by the person at a second later point in time;
c. analyzing the separation between the one or more teeth of the person and one or more alignment appliances worn by the person at the second later point in time to determine the movement of the one or more teeth of the person relative to the one or more alignment appliances worn by the person from the first point in time to the second later point in time; and
d. adjusting or replacing the one or more alignment appliances worn by the person or altering the treatment plan of the person based on the movement of the one or more teeth of the person as compared to the one or more alignment appliances worn by the person to align one or more teeth.

18. The method of claim 17, wherein adjusting the one or more alignment appliances includes causing at least a portion of an alignment appliance to apply one or more force pyramids to the one or more teeth.

19. The method of claim 17 wherein adjusting the one or more alignment appliances includes causing at least a portion of the alignment appliance to take a serpentine shape, contain a serpentine pattern or contain ridges.

20. The method of claim 17, further comprising storing in a fixed medium the data from measuring the separation between one or more teeth and one or more alignment appliances.

21. The method of claim 19, further comprising analyzing the stored data in the fixed medium to determine what forces should be applied to the one or more teeth to cause them to align relative to each other.
